(19) United States
(12) Patent Application Publication
(10) Pub. No.: US 2016/0223409 A1
(43) Pub. Date: Aug. 4, 2016

(54) Thermochromic Indicators

(71) Applicant: Landec Corporation, Menlo Park, CA (US)

(72) Inventors: Robert Parker, Bend, OR (US); Julian E. Shafer, Montara, CA (US); Steven P Bitler, Menlo Park, CA (US)

(21) Appl. No.: 15/097,987

(22) Filed: Apr. 13, 2016

Related U.S. Application Data
(63) Continuation-in-part of application No. 14/571,256, filed on Dec. 15, 2014.
Application No. 14/571,256 is a continuation of application No. 12/653,294, filed on Dec. 11, 2009, now Pat. No. 8,911,861.
(60) Provisional application No. 60/201,506, filed on May 3, 2000.
(60) Provisional application No. 62/146,894, filed on Apr. 13, 2015.

(51) Int. Cl. G01K 11/16

(52) U.S. Cl. CPC G01K 11/165

(57) ABSTRACT

This invention relates to an apparatus for indicating a temperature outside of a chosen range and the duration of time the temperature was outside that range. More specifically, it relates to the application of material to a label wherein temperatures above the material's melting point cause it to migrate on that label and indicate such temperatures were exceeded and, by the distance of that migration, the duration of time such temperatures were exceeded.

### CROSS-REFERENCE TO RELATED APPLICATION

This application is a continuation in part of U.S. patent application Ser. No. 14/571,256, filed Dec. 15, 2014, which is currently pending, that application is a continuation application of U.S. patent application Ser. No. 12/653,294, filed Dec. 11, 2009, which claims priority under 35 U.S.C. §119(e) to U.S. Provisional Application No. 60/201,506, filed Dec. 11, 2008 and U.S. Provisional Application No. 62/146,894, filed Apr. 13, 2015, and is related to U.S. Provisional Application No. 61/466,943, filed Mar. 24, 2011. The entire disclosures of each such application is incorporated by reference herein in for all purposes.

### BACKGROUND OF THE INVENTION

There are numerous temperature indicators both reversible and irreversible as available from companies including Temptime, Shockwatch, American Thermal Instruments, LCR Hallcrest, On Point Indicators, Biosynergy, Cold Chain Technologies, Dry Pak Industries, Freshpoint, JP Labs, Spirig, Syscon International, Tempil, 3M and others. In many cases these companies provide indicators that may be bulky and expensive to manufacture.

There are numerous patents and patent applications including those from Temptime: U.S. Pat. No. 5,057,434; U.S. Pat. No. 5,709,472; U.S. Pat. No. 6,042,264; U.S. Pat. No. 6,544,925; U.S. Pat. No. 6,924,148; U.S. Pat. No. 7,019,171; U.S. Pat. No. 7,161,023; U.S. Pat. No. 7,209,042; U.S. Pat. No. 7,343,872; U.S. Pat. No. 7,490,575; U.S. Pat. No. 7,517,146; U.S. Pat. No. 7,571,695; and US20070067177, which include a number of concepts including the conversion of diacetylenic monomers to polymers with a resulting color change as well as technology relating to crystalline materials moving along a wicking paper into a viewing window.

There are also newer applications, including from Landec, US20100247900, which disclose sharply melting polymeric materials, inter alia, optionally in the form of particles that can be easily spray deposited, where the sharply melting polymer exhibits a melt temperature that can be precisely tuned to a temperature indication point of interest.

Other technologies involve the use of waxes and configurations where the wax or other component is designed to penetrate into colored paper resulting in a indication of temperature change.

Many of the devices, from the companies mentioned above, result in large, bulky indicators that are difficult to miniaturize for incorporation into high speed label making formats. The diacetylenic technology developed by Temptime and described in, for example, U.S. Pat. No. 6,544,925 and U.S. Pat. No. 6,924,148, is costly and must be shielded not only from temperature but also from UV light since the diacetylenic monomers polymerize by heat, and UV light, radiation, etc.

There is a need for an indicator that will exhibit both temperature change and time in a combination that allows the viewer the ability to assess the “life” or “activity” remaining in a product. U.S. Pat. No. 5,709,472, and U.S. Pat. No. 6,042,264; from Temptime are large bulky items that are generally placed on exterior boxes or cartons and not on small labels placed on individual vials of a vaccine for example. These current indicators are generally designed to be about 2.5 cm in length or longer and about 1.5 cm wide or wider.

An inexpensive time and temperature indicating label small enough to be placed on each vial of a vaccine would be desired.

A number of different thermochromic indicators have been proposed in the past; see for example U.S. Pat. No. 2,799,167, the entire disclosure of which is incorporated by reference herein for all purposes.

### SUMMARY OF THE INVENTION

In a first aspect, this invention provides novel thermochromic indicators which comprise

(1) a solid substrate, and

(2) a coating on the substrate, wherein the coating comprises

(a) comprise a solid crystalline material having a crystalline melting point, Tp, of 0-135 deg. C., e.g. 35-105 deg. C.,

(b) when the coating is a temperature below Tp, cause the coating to have opacity resulting from the scattering of visible light, and

(c) when the coating is heated from a temperature below Tp to a temperature above Tp, melt and thus decrease the opacity (i.e. increase the translucency) of the coating.

In a second aspect, this invention provides novel methods of making thermochromic indicators in which compositions comprising particles of a solid crystalline material having a Tp of 0-135 deg. C., e.g. 35-105 deg. C., are deposited on, or formed on, a solid substrate.

In a third aspect, this invention provides novel methods of determining whether an object is at a temperature above (or below) a predetermined temperature, or has at some previous time been at a temperature above (or below) a predetermined temperature, making use of a thermochromic indicator comprising particles of a solid crystalline material having a Tp at the predetermined temperature.

### DETAILED DESCRIPTION OF THE INVENTION

In the Summary of the Invention above and in the Detailed Description of the Invention, the Examples, and the Claims below, reference is made to particular features (including method steps) of the invention. It is to be understood that the disclosure of the invention in this specification includes all appropriate combinations of such particular features. For example, where a particular feature is disclosed in the context of a particular aspect or embodiment of the invention, or a particular claim, that feature can also be used, to the extent appropriate, in combination with and/or in the context of other particular aspects and embodiments of the invention, and in the invention generally.

The term “comprises” and grammatical equivalents thereof are used herein to mean that other elements (i.e. components, ingredients, steps etc.) are optionally present. For example, a structure “comprising” (or “which comprises”) components A, B and C can contain only components A, B and C, or can contain not only components A, B and C but also one or more other components.

The terms “a”, “an” and “the” before an item are used herein to mean that there can be a single such item or two or more such items, unless the context makes this impossible. The term “consisting essentially of” and grammatical equivalents thereof is used herein to mean that other elements may be present which do not materially alter the disclosed invention. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). The term “at least” followed by a number is used herein to denote the start of a range beginning with that number (which may be a range having an upper limit or no upper limit, depending on the variable being defined). For example “at least 1” means 1 or more than 1, and “at least 80%” means 80% or more than 80%. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number)”, this means a range whose lower limit is the first number and whose upper limit is the second number. For example, “from 2 to 16 mm” or “2-16 mm.” means a range whose lower limit is 2 mm and whose upper limit is 16 mm. The numbers given herein should be construed with the latitude appropriate to their context and expression. The term “plurality” is used herein to mean two or more.

In describing and claiming the invention below, the following abbreviations, definitions, and methods of measurement (in addition to those already given) are used.

Parts and percentages are by weight, except where otherwise noted. Temperatures are in degrees Centigrade. For crystalline materials, the abbreviation To is used to mean the onset of melting, the abbreviation Tp is used to mean the crystalline melting point, and the abbreviation DELTA H is used to mean the heat of fusion. To, Tp and DELTA H are measured by means of a differential scanning calorimeter (DSC) at a rate of 10 deg. C./minute and on the second heating cycle. To and Tp are measured in the conventional way well known to those skilled in the art. Thus Tp is the temperature at the peak of the DSC curve, and To is the temperature at the intersection of the baseline of the DSC peak and the onset line, the onset line being defined as the tangent to the steepest part of the DSC curve below Tp.

The abbreviations Mn and Mw are used to denote number average and weight average molecular weight in daltons, respectively, measured in tetrahydrofuran using size exclusion chromatography, configured with a Wyatt laser light scattering detector

The abbreviation CxA is used to denote an n-alkyl acrylate in which the n-alkyl group contains x carbon atoms, the abbreviation Cx alkyl is used to denote an n-alkyl group which contains x carbon atoms, and the abbreviation CxM is used to denote an n-alkyl methacrylate in which the n-alkyl group contains x carbon atoms. Other abbreviations are given elsewhere in the specification.

The side chain crystalline (SCC) polymers used in the present invention can be homopolymers, or copolymers of two or more comonomers, including random copolymers, graft copolymers and block copolymers (including thermoplastic elastomers). The presence of units derived from comonomers containing functional groups can be useful in improving the compatibility of the SCC polymer with a matrix polymer and/or in changing the refractive index of the SCC polymer. Two or more SCC polymers can be used together. The number average molecular weight of the SCC polymer is for example from 10,000 to 1,500,000. The molecular weight of an SCC polymer is relatively unimportant to its Tp, whereas it is generally an important factor in determining the Tp of other polymers.

The SCC polymers preferably used in the present invention are in themselves well known. Publications describing SCC polymers include U.S. Pat. Nos. 4,830,855, 5,120,349, 5,156,911, 5,129,180, 5,156,911, 5,254,354, 5,387,450, 5,412,035, 5,469,867, 5,752,926 5,665,822, 5,783,302, 5,752,926, 5,807,291, 5,469,867, 5,826,584, 6,013,293, 6,060,540, 6,199,318, 6,210,724, 6,224,793, 6,255,367, 6,376,032, 6,492,462, 6,540,984, 6,548,132, 6,831,116, 6,989,417 and 7,101,928, US Publication will Numbers 2001/0018484, 2002/0090425 and 2002/0127305, J. Poly. Sci. 60, 19 (1962), J. Poly. Sci, (Polymer Chemistry) 7, 3053 (1969), 9, 1835, 3349, 3351, 3367, 10, 1657, 3347, 18, 2197, 19, 1871, J. Poly. Sci, Poly-Physics Ed 18 2197 (1980), J. Poly, Sci, Macromol. Rev, 8, 117 (1974), Macromolecules 12, 94 (1979), 13, 12, 15, 18, 2141, 19, 611, JACS 75, 3326 (1953), 76; 6280, Polymer J 17, 991 (1985); and Poly. Sci USSR 21, 241 (1979). The entire disclosure of each of those United States patents is incorporated in this specification by reference.

The SCC polymer may for example be derived from one or more acrylic, methaciylic, olefinic, epoxy, vinyl, ester-containing, amide-containing or ether-containing monomers. Preferred SCC polymers comprise repeating units in which the side chains comprise linear polymethylene radicals containing 12 to 50, e.g., 16-30, carbon atoms and/or at least 5, e.g. 5 to 49, preferably at least 8, linear perfluorinated or substantially perfluorinated methylene moieties and a terminal perfluoromethyl moiety or hydrogen atom. The greater the number of linear polymethylene radicals, the higher the Tp of the polymer. Specific examples of suitable crystalline alkyl moieties include C14, C16, C18, C20, C22, C30, C40 and C50 alkyl.

### The Tp of the Crystalline Particles.

The Tp of the crystalline particles, and the temperature range over which melting takes place, determines the temperature range over which the opacity of the coating on the substrate will change. The Tp can for example be 20-100 deg. C., or 30-70 deg. C., or 40-60 deg. C.. The smaller the temperature range over which melting takes place, the more abrupt the change in opacity. Although microcrystalline waxes and other conventional crystalline materials can be used in this invention, such materials often do not have a Tp at the desired level and/or melt over a relatively extended temperature range and/or have only limited crystallinity. An advantage of using SCC polymers is that they can be tailored to have any desired Tp and to melt over a limited temperature range. Thus, the SCC polymers preferably used in this invention preferably have an onset of melting temperature, To such that Tp-To is less than Tp0.7, generally less than Tp0.6, To and Tp being in deg. C., particularly less than 10 deg. C., especially less than 5 deg. C. The crystallinity of the SCC polymer is preferably such that its heat of fusion is at least 20 J/g, particularly at least 40 J/g. Tp is often chosen so that, at ambient temperature, the particles are at a temperature below Tp, in which case the opacity of the coating will decrease when the indicator temperature rises above Tp. However, it is also possible for Tp to be such that, at ambient temperature, the particles are at a temperature above Tp (although they must be solid, for example as a result of cross-linking of the particles themselves and/or of a matrix polymer surrounding them), in which case the opacity of the coating will increase when the temperature falls below Tp.

### The Size of the Particles.

The particles must have a size such that the coating, at temperatures below Tp, scatters light.

Coatings with Small Quantities of a Binder.

In some embodiments, the coating consists essentially of the crystalline particles, air voids and a small quantity, e.g. 5-40% by weight of the coating, of a binder. The binder can for example be a polymer having a Tg at least 10 deg. C. below the Tp of the crystalline polymer, and optionally having a minimum film forming temperature (MFFT) less than 0 deg. C., preferably between −30 deg. C. and 0 deg. C., and optionally having been formed by partial coalescence of binder polymer particles having a size less than 0.15 micrometers (mu), preferably less than 0.12 mu, particularly less than 0.10 mu

This type of coating, once it has been made translucent by heating above Tp, is irreversible, i.e. remains translucent even after cooling below Tp. The coating contains, for example, 60-90%, preferably 70-80%, by weight of the particles. Such a coating can be formed by depositing a liquid composition containing the particles onto the substrate, and solidifying the composition at a temperature below Tp. The light scattering produced by such a coating depends upon the difference in refractive index between the crystalline particles and the air in the voids, which is high, and the concentration of the particles, which is also high. Consequently, the thickness of the coating can be quite small. For example, the thickness can be at least 0.025 millimeter (mm) or at least 0.05 mm, for example least 0.1 mm, e.g. can be 0.1-0.2 mm. In this embodiment, a small range of particle sizes is desirable because it improves light scattering efficiency by maximizing void volume. For example, the particles can have a median particle size, p, which is (a) less than 10 mu, preferably less than 5 mu, and (b) greater than 0.3 mu, preferably 0.3 to 2 mu for example 0.5 to 1.0 mu particularly 0.7 to 0.81 mu; and preferably at least 90% of the particles have a size between 0.8 p and 1.2 p, for example between 0.9 p and 1.1 p, particularly between 0.95 p and 1.05 p.

However, this type of coating is often fragile and for many uses may require a protective coating. A more robust coating of this kind can be prepared by making use of particles composed of a core-shell polymer, with the core being the polymer having the desired Tp, and the shell being a polymer which permits partial coalescence of particles during solidification of the liquid composition.

Coatings in which the Particles are Dispersed in a Matrix Polymer.

In other embodiments, the crystalline particles are dispersed in a matrix polymer. The coating can for example contain 20-70%, e.g. 40-65% or 50-60%, by weight of the particles. If the particles remain substantially intact in the matrix polymer at temperatures above Tp, then the thermochromic indicator is reversible, since the particles revert to a crystalline state if the indicator is cooled below Tp. To achieve reversibility, the crystalline particles themselves can be cross-linked, and/or the matrix polymer can be cross-linked. When the particles are dispersed in a matrix polymer, with few if any air voids, the light scattering depends upon the difference in refractive index between the crystalline particles and the matrix polymer. This difference is always much less than the difference between the refractive index of the crystalline particles and air; consequently the thickness of the coating is preferably relatively high in order to obtain a practically useful degree of opacity. For example, the thickness of the coating is preferably at least 1 mm, for example 1-2 mm. At temperatures below Tp, the difference in refractive index is preferably high for maximum opacity, for example at least 0.04 or at least 0.05. However, at temperatures above Tp, the difference is preferably small for maximum ranslucency. Crystalline materials generally have a refractive index above Tp which is below, for example about 0.03-0.04 below, the refractive index below Tp. Preferably the crystalline particles have a refractive index above Tp which is at least 0.03, particularly at least 0.04, less than the refractive index below Tp, and which is preferably not more than 0.03 greater, particularly not more than 0.02 greater, especially not more than 0.01 greater, than the refractive index of the matrix polymer.

A wide range of matrix polymers can be used in this invention. The matrix polymer should provide a translucent, noncrystalline, continuous matrix throughout the operational temperature of the indicator. For example, when the indicator is to be used to determine a relatively low temperature, the matrix polymer can be chosen primarily with a view to its refractive index and compatibility with the crystalline particles, for example a polyacrylate available from Rohm Haas (Dow). When higher temperatures are involved, these factors remain important, but it may be necessary to make use of higher melting matrix polymers, e.g. polysiloxanes, for example those available from Dow Corning. The matrix polymers that can be used include polysiloxanes, epoxy resins, polyesters, unsaturated polyesters, polyvinyl esters, polyurethanes, polyacrylates, polymethacrylates and polystyrenes, and combinations of two or more of these.

### Optional Ingredients of the Coating.

The coating containing the crystalline particles can contain other conventional ingredients, for example antioxidants, UV stabilizers, extenders, fillers, defoamers which facilitate the application of the coating composition onto the substrate for example by printing. The coating (including the crystalline particles themselves) can also optionally be lightly tinted with dyes or pigments, so that the coating, below Tp, is slightly colored (e.g., light green or yellow or any other color) rather than merely white, and the objective is to produce a coating which, above Tp, is translucent, rather than transparent. Preferably, the coating is produced by coating the substrate by a punting technique.

### Substrates.

In some cases, the substrates are colored (including for example printed with a message), so that when the coating becomes translucent, the substrate determines the appearance of the indicator. In other cases, the substrate is transparent or translucent and the indicator is, in use, placed on the top of a colored base (including, again, a printed base), whose color then determines the appearance of the indicator when the coating becomes translucent.

### Multiple Coatings.

Multiple coatings, containing crystalline particles having different Tps can be placed on the same substrate, spaced-apart from each other and/or one on top of each other, so that the indicator is triggered in different ways by different temperatures.

### Uses of the Temperature Indicators.

The temperature indicators can be used in a wide variety of applications, including for example the following, using for example a Tp as shown.

Reversible.

1. 50-55 deg. C. pot handles—appliances—burning skin warning.

2. 38 deg. C. incubators—heat trace for pipe lines to reduce oil viscosity.

3. 70 deg. C. hair curlers—electric wiring—current breakers.

4. 100 deg. C. steam traps—steam lines—hydraulic lines.

5. 110 deg. C. tire overheating.

6. 1-2 deg. C. black ice road signs—pot dots.

7. Bearings over temp.

8. Nip rollers for heat laminating.

9. 105 deg. C. transformers—power lines,

10. Outdoor temperature display billboards

11. Refrigeration—food processing.

Irreversible.

1. Brake linings over temperature.

2. Vaccine over temperature.

3. Shipping frozen blood—blood bags.

4. Sterilization indicators.

5. Defrost or thaw indicators.

6. Process control.

The invention is illustrated in the following examples. Examples 1-8 show irreversible thermochromic indicators. Examples 9-13 show reversible thermochromic indicators,

### Example (1)

Crystalline polymer: 311-88 is a 0.3 micron median particle size anionic crystalline polymer emulsion at 41.9% NV solids neutralized with ammonia to pH 7.2 in 80:20 water:n-propanol with a viscosity of 83 centipoise. The dry polymer, primarily based on a mixture of 92% docosyl acrylate, 6% methacrylic acid and 2% butyl-3-mercaptopropionate, exhibits a strong endotherm at 65 deg. C. when tested by DSC at a 10 deg. C./min heating rate. When coated with 3 wet mils Bird film applicator on a black Leneta chart, the bluish white emulsion dries at room temperature to a semi-gloss white moderately opaque film that is easily rubbed from the chart to a flaky powder. This dry white film, when heated for 2 minutes in a 70 deg. C. oven, becomes mostly transparent whereupon a dense pattern of 0.1-0.2 ram cracks is evident in a slightly adherent but brittle film. When the same 3 mils wet film is dried immediately in the 70 deg. C. oven, it dries quickly to a nearly defect-free transparent and somewhat flexible film that is difficult to rub off.

### Example (2)

Crystalline polymer: 319-188 is a 0.8 micron median particle size anionic crystalline polymer emulsion at 51.8% NV solids neutralized with ammonia to p1-1 7,8 in 83:17 water:n-propanol with a viscosity of 48 centipoise. The dry polymer, based on a mixture of 51% stearyl acrylate, 37% cetyl acrylate, 8% 2-ethylhexyl acrylate, 4% methacrylic acid and 0.5% 1,6-hexanediol diacrylate, exhibits a strong endotherm at 38 deg. C. when tested by DSC at a 10 deg. C./min heating rate. When coated with 3 wet mils Bird film applicator on a black Leneta chart, the opaque white emulsion dries at room temperature to opaque white matte film that is easily rubbed from the chart to a flaky powder. The opaque film, when heated for 5 minutes in a 50 deg. C. oven, becomes mostly transparent whereupon a dense pattern of 0.1-0.2 ram cracks is evident in a slightly adherent but brittle film. When the same 3 mils wet film is dried immediately in the 70 deg. C. oven, it dries quickly to a nearly defect-free transparent and somewhat flexible film that is difficult to rub off.

### Example (3)

Binding polymer: N-484 is a 0.1 micron median particle size anionic amorphous styrene-acrylic emulsion polymer at 50.3% NV solids at pH 8.4 in water with a viscosity of 50 centipoise. The dry polymer, based on approximately 69% n-butyl acrylate, 20% methyl methacrylate, 10% styrene and 1% methacrylic acid, exhibits a distinct glass transition at minus 21 deg. C. It air dries to a glossy, somewhat tacky, strongly adherent rubbery transparent film at room temperature with no visible defects.

### Example (4)

Thermochromic coating: 319-190 is an irreversible thermochromic coating formulated from the crystalline polymer emulsion 319-188 described in example (2). 130.7 gr of binding polymer N-484 was stirred into 831.4 gr of 319-188 emulsion and followed with 15.6 gr of Acrysol TT-935 thickener pre-diluted with an equal amount of water. To this mixture is added 1.3 gr of Tego Foamex 1488 antifoam and finally 5.4 gr of 14% aqueous ammonia to neutralize and activate the thickener. The resulting coating formulation equilibrates overnight to 1300 centipoise viscosity at 50.5% NV solids and pH 8.2. The polymer portion of this coating is comprised of 86% crystalline polymer, 13.1% binding polymer and 0.9% thickener polymer, or a ratio of 61/2 to 1 of crystalline to binding polymer. This coating looks much like a white latex paint and can be applied easily by various standard methods including brush, roller, Bird film applicator etc. It dries to an opaque white semi-gloss film at room temperature with no visible defect other than buffing easily to a higher gloss film. When applied at 3 wet mils on a black Leneta chart, the dry white film almost completely covers the black background. Unlike the unmodified crystalline polymer, this coating adheres well to the chart though it is somewhat soft and can be scraped off as a gum without dusting or flaking. This dry film remains fully opaque with no visible change when heated to 30 deg. C. and 35 deg, C. When placed in a 40 deg. C. oven, however, it changes dramatically in less than 30 seconds completely revealing the black background with no trace of opacity remaining, now adhering to the chart even more strongly than before. On cooling, this film simply gets more rigid, remaining flexible, adherent and as transparent as the film produced when the wet coating is dried at 50 deg. C. never reaches opacity.

### Example (5)

Crystalline polymer: 350-112 is a 0.76 micron median particle size anionic crystalline polymer emulsion at 51.0% NV solids neutralized with ammonia to pH 4.8 in 83:17 water:n-propanol with a viscosity of 28 centipoise. The dry polymer, based on a mixture of 93% docosyl acrylate, 4% 2-ethylhexyl acrylate, 2.5% methacrylic acid and 0.5% 1,6-hexanediol diacrylate, exhibits a strong endotherm at 62 deg. C. when tested by DSC at a 10 deg. C./min heating rate. When coated with #60 Meyer rod on a black Leneta chart, the opaque white emulsion dries at room temperature to opaque white but badly cracked film that is easily rubbed from the chart to a fine, flaky powder. The opaque film, when heated for 5 minutes in a 50 deg. C. oven, remains unchanged in appearance but, when the temperature is raised to 74 deg. C., it becomes mostly transparent whereupon a dense pattern of 0.1-0.2 mm cracks is evident in a slightly adherent but brittle film. When the same 3 mils wet film is dried immediately in the 70 deg, C. oven, it dries quickly to a nearly defect-free transparent and somewhat flexible film that is difficult to rub off When the emulsion was neutralized further with ammonia to pH 8.4, the appearance and viscosity remain unchanged but the degree of cracking was slightly reduced on drying, whether heated or not.

### Example (6)

Thermochromic coating: 349-19 is an irreversible thermochromic coating formulated from the crystalline polymer emulsion 350-112 described in example (5). 127.9 gr of binding polymer N-484 was stirred into 807.3 gr of 350-112 emulsion and followed with 19.4 gr of Acrysol TT-935 thickener pre-diluted with 30.5 gr of water. To this mixture was added 1.0 gr of Tego Foamex 1488 antifoam and finally 14.0 gr of 14% aqueous ammonia to neutralize and activate the thickener. The resulting coating formulation, at 48.1% NV solids and pH 8.0, equilibrated overnight to a thixotropic white paint with 1292 centipoise viscosity @ 60 rpm and 3670 centipoise @ 12 rpm (Brookfield LVT, #3 spindle @20 deg. C.). The polymer portion of this coating is comprised of 85.4% crystalline polymer, 13.4% binding polymer and 1.2% thickener polymer, or a ratio of 6.4 to 1 of crystalline to binding polymer. The coating, applied at 3 wet mils with Bird film applicator to a black Leneta chart, dried to an opaque white to a low sheen film at room temperature with a few barely visible cracks at the edges. The somewhat brittle coating adhered well to the chart and could be scraped off as small flakes. When the same wet film was dried at 50 deg. C., it reached the same level of opacity but with somewhat higher gloss, better adhesion and fewer defects. This dry film remained fully opaque with no to visible change until heated to 63 deg. C., whereupon it changed dramatically in about one minute, completely revealing the black chart background with no trace of opacity remaining, now adhering to the chart even more strongly than before though not quite as tough as the clear film formed when the coating is dried at 74 deg. C. When cooled back to room temperature, the film was non-tacky, remained fully transparent and could be bent over a ⅛″ mandrel without cracking.

### Example (7)

Crystalline polymer: 350-124 is a 0.72 micron median particle size anionic crystalline polymer emulsion at 51.0% NV solids neutralized with ammonia to pH 7.0 in 83:17 water:n-propanol with a viscosity of 28 centipoise. The dry polymer, based on a mixture of 93% docosyl acryl ate, 4% 2-ethylhexyl acrylate, 2.5% methacrylic acid and 0.5% 1,6-hexanediol diacrylate, exhibits a strong endotherm at 53 deg. C. when tested by DSC at a 10 deg. C./min heating rate. When coated with 3 wet mils Bird film applicator on a black Leneta chart, the opaque white emulsion dried at room temperature to opaque white matte film that is easily rubbed from the chart to a flaky powder. The opaque film, when heated for 5 minutes in a 50 deg. C. oven, remained visibly unchanged until the temperature was increased to 54 deg. C. where it lost opacity but the residue appeared hazy due to the poorly adherent dense pattern of 0.1-0.2 mm in a film that turned brittle on cooling. When the same wet film was dried in the 74 deg. C. oven, it immediately lost opacity and became a nearly transparent but visibly cracked adherent film which was brittle on cooling that scratched easily but was somewhat difficult to rub off.

### Example (8)

Thermochromic coating: 349-20 is an irreversible thermochromic coating formulated from the crystalline polymer emulsion 350-124 described in example (7). 136.9 gr of binding polymer N-484 was stirred into 802.9 gr of 350-124 emulsion and followed with 26.0 gr of Acrysol TT-935 thickener pre-diluted with 20.8 gr of water. To this mixture was added 1.0 gr of Tego Foamex 1488 antifoam and finally 10.6 gr of 14% aqueous ammonia to neutralize and activate the thickener. The resulting coating formulation equilibrated overnight to 1010 centipoise viscosity at 48.5% NV solids and pH 8.5. The polymer portion of this coating is comprised of 83.5% crystalline polymer, 14.8% binding polymer and 1.7% thickener polymer, or a ratio of 5.7 to 1 of crystalline to binding polymer. This coating appeared very much like 349-19 in example (6), with comparable opacity when wet and dry, though with no visible defects even when dried at room temperature. It remained opaque even when dried at 50 deg. C. but, as expected, the dry film became transparent on heating to 54 deg. C. and remained so when cooled back to room temperature. The cooled film was more rigid but still flexible, non-tacky and easily handled without damage

### Example (9)

Crystalline polymer emulsion: 350-112 is a 0.76 micron median particle size anionic emulsion at 51.0% NV at pH 4.8 in 83:17 water:n-propanol with a viscosity of 28 centipoise. The dry lightly crosslinked polymer, based on a mixture of 93% docosyl acrylate. 4% 2-ethylhexyl acrylate, 2.5% methacrylic acid and 0.5% 1,6-hexanediol diacrylate, exhibits a strong endotherm at 62 deg. C. when tested by DSC at a 10 deg. C./min heating rate. When coated with #60 Meyer rod on a black Leneta chart, the opaque white emulsion dries at room temperature to opaque white but badly cracked film that is easily rubbed from the chart to a fine, flaky powder. This dry white polymer deposit, when heated for 2 minutes in a 70 deg. C. oven, became mostly transparent and showed a dense pattern of 0.1-0.2 mm cracks in a brittle film. The refractive index of this transparent but somewhat cracked film was tested using an ATAGO RS000 hand refractometer. The index at 30 deg. C. measured at about 1.50 in its crystalline state. The instrument could not, however, be heated safely to 65 deg. C. to measure it in the amorphous state. Uncrosslinked crystalline polymers made with similar composition (from octadecyl acrylate monomer) have been tested for refractive index giving a 1.46 index in their amorphous (melted) state.

### Example (10)

Crystalline polymer powder: 350-205 A is a powdered solid prepared from crystalline emulsion polymer 350-112 described in Example (1). 225 gr of 350-112 emulsion was chilled to 10 deg. C., poured into a chilled metal baking pan and the pan placed in a vacuum chamber over a bucket of dry ice. The polymer was freeze dried without agitation in this manner at 30 in Hg vacuum for 17 hours. The dry, white flaky residue was removed and placed in a pre-chilled Waring blender and pulverized for 1 minute at high speed. This powder was used to prepare several experimental reversible coatings. The 350-205 A powder was also suspended separately in methanol, sheared for 30 sec with a Virtis homogenizer and tested for particle size distribution with a Horiba. LA-910 laser light scattering analyzer. The result indicated about 30% of the particles remained at 0.7 microns with the remaining agglomerates distributed between 3 and 30 microns.

### Example (11)

Reversible coating: 6.67 gr of Silgard 184, a dimethylsilicone based elastomer base resin from Dow Corning, was mixed with 4.0 gr 350-205 A, the powdered crystalline polymer from example (2), and 0.66 gr of Silgard 184 silicone curing agent plus additional platinum catalyst in the form of 6 drops Syl-Off 4000 (Platinum/vinyl siloxane based catalyst also from Dow Corning). The blend was mixed briefly with a spatula and then with Virtis homogenizer until free of lumps. The coating cured in 2 hours at room temperature to a grainy white rubbery film. The coating was heated to 70 deg. C. and it lost some but not all of its opacity when hot. On cooling back to room temperature the original degree of opacity returned. The incomplete transparency shown in the heated state is presumably due to a refractive index mismatch between the 1.43 RI silicone and the 1.46 RI crystalline polymer.

### Example (12)

Reversible coating: 6.03 gr of 350-112 crystalline polymer emulsion described in example (1) was diluted with 7.03 gr methanol and stirred in 0.12 gr Silwet L-77 (Polyalkylene modified heptamethyltrisiloxane—Osi Specialties). Added this smooth polymer suspension to 10.0 gr PDV-1631, a vinyl terminated diphenyl siloxane-dimethyl siloxane copolymer from Gelest with 16% diphenyl for a refractive index of 1.465. This siloxane/polymer mixture was homogenized for 1 minute using a Virtis hand-held homogenizer to a smooth white cream. To the creamy mixture was added 0.2 gr SIP6830.3, a divinyl tetramethyldisiloxane complex with 3% Pt from Gelest, followed by 0.25 gr SIP6826.0, a phenyltris(dimethysiloxy)silane crosslinker from Gelest. This catalyzed coating mixture, 349-56 C, was homogenized for one minute, applied to a black Leneta chart and cured 4 hours in an oven at 50 deg. C. The result, when cooled to room temperature, was a slightly opaque white rubbery film with some graininess from some agglomeration of the crystalline polymer powder. On heating to 70 deg. C., the film became almost completely transparent on cooling again to room temperature, it regained opacity. In this example, we have a better match between the 1.465 RI silicone and the 1.46 RI crystalline polymer.

Another embodiment is an indicator comprising one or more acrylic polymers with chain lengths of about 12, 14, 16, 18, and 22 carbons, wherein such polymer comprises at least one functional groups selected from the group consisting of COOH, OH, NH₂, NR₂, siloxy, ester, and amide; wherein said indicator exhibits a known state transition temperatures and viscosity characteristics to indicate a temperature outside of a chosen temperature range, and indicate a period of time outside of a chosen temperature range.

The indicator may transition from a solid to a liquid and may employ a material with known state transition temperatures, and a first component and a second component, wherein, in a chosen temperature range, said first and second components are kept separate by said material and outside of said temperature range said material changes state, allowing said components to mix and indicate a temperature outside of said temperature range.

Another embodiment is an indicator employing a material with known state transition temperatures, and a first component and a second component, both said components having known viscosity characteristics, wherein in a chosen temperature range said first and second components are kept separate by said material and outside of said temperature range said material changes state, allowing at least one said component to travel and mix with the other and thereby indicate a temperature outside of said temperature range and indicate a time outside of said temperature range. The material may also be employed as one of the components.

Another embodiment is an indicator comprising: a substrate, and a coating on the substrate comprising a polymeric composition comprising one or more side chain crystalline (SCC) polymer(s) wherein when the composition is heated from a temperature below T₁ to a temperature above T₁, the indicator changes color.

Another embodiment is a method of detecting a temperature change using an indicator, wherein the indicator comprises a substrate and a coating on the substrate comprising a polymeric composition comprising one or more side chain crystalline (SCC) polymer(s) wherein when the composition is heated from a temperature below T₁ to a temperature above T₁, said indicator provides an indication of time above T₁ wherein the polymer would provide the non-reversible indication faster as the temperature rises.

The indicator may include side chain crystalline (SCC) polymers which can be homopolymers, or copolymers of two or more comonomers selected from the group consisting of random copolymers, graft copolymers, and block copolymers. In some embodiments, the side chain crystalline (SCC) polymer is derived from one or more monomers. One or more of the monomers may be selected from the group consisting of acrylic, methacrylic, olefinic, epoxy, vinyl, ester-containing, amide-containing, and ether-containing monomers. In a preferred embodiment, the indicator comprises a component containing 16 carbons as a monomer or comonomer in the polymer. The indicator comprises a component comprising 12 carbons as a monomer or comonomer in the polymer in another embodiment. The indicator may comprise components comprising 16 carbons and 12 carbons as a monomer or comonomer in the polymer and an alcohol. The indicators herein may employ one or more of the monomers are selected from the group consisting of acrylic, methacrylic, olefinic, epoxy, vinyl, ester-containing, amide-containing, and ether-containing monomers. In some embodiments the indicator color change can be irreversible. The indicator, for example, may be used to indicate a temperature change with a vaccine.

Another embodiment of the invention is an indicator assembly which comprises, for example,

(1) a substrate which comprises a temperature-sensitive product, and
(2) a temperature indicator which
(a) comprises a side chain crystalline (SCC) polymer which (i) has a crystalline melting point, Tp, of 0-135° C., and (ii) is not cross-linked
(b) undergoes an irreversible change when exposed to a temperature which damages the temperature-sensitive product, wherein the change first occurs as the SCC polymer is exposed to temperature from below Tp to a temperature above Tp, wherein the SCC polymer is a copolymer of two or more comonomers, and comprises repeating units in which the side chains comprise linear polymethylene radicals containing 16-30 carbon atoms.

The assembly may contain a SCC polymer that is a copolymer which consists essentially of units derived from (a) the n-alkyl acrylate in which the n-alkyl group contains 12 carbon atoms and (b) the n-alkyl acrylate in which the n-alkyl group contains 16 carbon atoms.

The assembly may contain a SCC polymer consists essentially of units derived from

(i) at least 50% by weight of at least one n-alkyl acrylate or methacrylate in which the n-alkyl group contains 12-50 carbon atoms, and
(ii) less than 50% by weight of at least one alkyl acrylate or methacrylate in which the alkyl group is not an alkyl group containing 12-50 carbon atoms.

In some embodiments, the temperature indicator undergoes an irreversible change when exposed to a combination of time and temperature which damages the temperature-sensitive product.

A preferred embodiment is an assembly which comprises.

(1) a substrate which comprises a vaccine, and.
(2) a temperature indicator which
(a) comprises a side chain crystalline (SCC) polymer which
(i) has a crystalline melting point, Tp, of 0-135° C.,
(ii) is not cross-linked,
(iii) is a copolymer of two or more comonomers, and
(iv) comprises repeating units in which the side chains comprise linear polymethylene radicals containing 16-30 carbon atoms,
(v) has a heat of fusion of at least 20 J/g, and
(b) undergoes an irreversible change when exposed to a combination of time and temperature which damages the vaccine wherein the change first occurs when exposed to a temperature from below Tp to greater than Tp.

In one embodiment the assembly employs a SCC polymer is a copolymer which comprises repeating units containing an n-alkyl group which contains 12, 14, 16 or 18 carbon atoms. In another embodiment the assembly employs a SCC polymer is a copolymer which consists essentially of units derived from the n-alkyl acrylate in which the n-alkyl group contains 12 carbon atoms and the n-alkyl acrylate in which the n-alkyl group contains 16 carbon atoms.

Another embodiment of the indicator assembly may use a SCC polymer that consists of units derived from

(i) at least 50% by weight of at least one n-alkyl acrylate in which the n-alkyl group contains 12-50 carbon atoms, and
(ii) less than 50% by weight of at least one alkyl acrylate in which the alkyl group is not an alkyl group containing 12-50 carbon atoms.

An assembly which comprises

(1) a substrate which comprises a temperature-sensitive product, and
(2) a temperature indicator which
(a) comprises a side chain crystalline (SCC) polymer which (i) has a crystalline melting point, Tp, of 0-135° C., and (ii) is not cross-linked
(b) becomes flowable when exposed to a temperature greater than Tp;
wherein the temperature indicator operates when exposed to a temperature range from below Tp to a temperature greater than Tp.

The assembly may employ a SCC polymer that becomes flowable at a temperature equal to or less than 6° C. above Tp and or has a heat of fusion of at least 20 J/g.

### Examples (13)

### Reversible Coating

A coating composition was made by mixing 48% by weight of Sylgard 184 (a Dow Corning silicone resin), 3% by weight of Sylgard 184 Dow Corning curing agent, 48% by weight of Polywax 655 from Baker Petrolite (Tp about 100 deg. C.), which had been micronized to a particle size of 3-10mu, and 1% by weight of platinum. The coating composition was mixed with a homogenizer, knife coated on black paper to form a film. 0.001 inch (about 5.4 mu) thick, and cured. When the resulting coated paper was heated with a heat gun to a temperature above 100 deg. C., the coating became substantially transparent. On cooling, the coating again became opaque. This cycle could be repeated.

### EXAMPLES

### (US20100247900)

### Example (1)

Crystalline polymer: 311-88 is a 0.3 micron median particle size anionic crystalline polymer emulsion at 41.9% NV solids neutralized with ammonia to pH 7.2 in 80:20 water:n-propanol with a viscosity of 83 centipoise. The dry polymer, primarily based on a mixture of 92% docosyl acrylate, 6% methacrylic acid and 2% butyl-3-mercaptopropionate, exhibits a strong endotherm at 65 deg. C. when tested by DSC at a 10 deg. C./min heating rate. When coated with 3 wet mils Bird film applicator on a black Leneta chart, the bluish white emulsion dries at room temperature to a semi-gloss white moderately opaque film that is easily rubbed from the chart to a flaky powder. This dry white film, when heated for 2 minutes in a 70 deg. C. oven, becomes mostly transparent whereupon a dense pattern of 0.1-0.2 mm cracks is evident in a slightly adherent but brittle film. When the same 3 mils wet film is dried immediately in the 70 deg. C. oven, it dries quickly to a. nearly defect-free transparent and somewhat flexible film that is difficult to rub off.

### Example (2)

Crystalline polymer: 319-188 is a 0.8 micron median particle size anionic crystalline polymer emulsion at 51.8% NV solids neutralized with ammonia to pH 7.8 in 83:17 water:n-propanol with a viscosity of 48 centipoise. The dry polymer, based on a mixture of 51% stearyl acrylate, 37% cetyl acrylate, 8% 2-ethylhexyl acrylate, 4% methacrylic acid and 0.5% 1,6-hexanediol diacrylate, exhibits a strong endotherm at 38 deg. C. when tested by DSC at a 10 deg. C./min heating rate. When coated with 3 wet mils Bird film applicator on a black Leneta chart, the opaque white emulsion dries at room temperature to opaque white matte film that is easily rubbed from the chart to a flaky powder. The opaque film, when heated for 5 minutes in a 50 deg. C. oven, becomes mostly transparent whereupon a dense pattern of 0.1-0.2 mm cracks is evident in a slightly adherent but brittle film. When the same 3 mils wet film is dried immediately in the 70 deg. C. oven, it dries quickly to a nearly defect-free transparent and somewhat flexible film that is difficult to rub off.

### Example (3)

Binding polymer: N-484 is a 0.1 micron median particle size anionic amorphous styrene-acrylic emulsion polymer at 50.3% NV solids at pH 8.4 in water with a viscosity of 50 centipoise. The dry polymer, based on approximately 69% n-butyl acrylate, 20% methyl methacrylate, 10% styrene and 1% methacrylic acid, exhibits a distinct glass transition at minus 21 deg. C. It air dries to a glossy, somewhat tacky, strongly adherent rubbery transparent film at room temperature with no visible defects.

### Example (4)

Thermochromic coating: 319-190 is an irreversible thermochromic coating formulated from the crystalline polymer emulsion 319-188 described in example (2). 130.7 gr of binding polymer N-484 was stirred into 831.4 gr of 319-188 emulsion and followed with 15.6 gr of Acrysol TT-935 thickener pre-diluted with an equal amount of water. To this mixture is added 1.3 gr of Tego Foamex 1488 antifoam and finally 5.4 gr of 14% aqueous ammonia to neutralize and activate the thickener. The resulting coating formulation equilibrates overnight to 1300 centipoise viscosity at 50.5% NV solids and pH 8.2. The polymer portion of this coating is comprised of 86% crystalline polymer, 13.1% binding polymer and 0.9% thickener polymer, or a ratio of 6½ to 1 of crystalline to binding polymer. This coating looks much like a white latex paint and can be applied easily by various standard methods including brush, roller, Bird film applicator etc. It dries to an opaque white semi-gloss film at room temperature with no visible defect other than buffing easily to a higher gloss film. When applied at 3 wet mils on a black Leneta chart, the dry white film almost completely covers the black background. Unlike the unmodified crystalline polymer, this coating adheres well to the chart though it is somewhat soft and can be scraped off as a gum without dusting or flaking. This dry film remains fully opaque with no visible change when heated to 30 deg. C. and 35 deg, C. When placed in a 40 deg. C. oven, however, it changes dramatically in less than 30 seconds completely revealing the black background with no trace of opacity remaining, now adhering to the chart even more strongly than before. On cooling, this film simply gets more rigid, remaining flexible, adherent and as transparent as the film produced when the wet coating is dried at 50 deg. C. never reaches opacity.

### Example (5)

Crystalline polymer: 350-112 is a 0.76 micron median particle size anionic crystalline polymer emulsion at 51.0% NV solids neutralized with ammonia to pH 4.8 in 83:17 water:n-propanol with a viscosity of 28 centipoise. The dry polymer, based on a mixture of 93% docosyl acryl ate, 4% 2-ethylhexyl acrylate, 2.5% methacrylic acid and 0.5% 1,6-hexanediol diacrylate, exhibits a strong endotherm at 62 deg. C. when tested by DSC at a 10 deg. C./min heating rate. When coated with #60 Meyer rod on a black Leneta chart, the opaque white emulsion dries at room temperature to opaque white but badly cracked film that is easily rubbed from the chart to a fine, flaky powder. The opaque film, when heated for 5 minutes in a 50 deg. C. oven, remains unchanged in appearance but, when the temperature is raised to 74 deg. C., it becomes mostly transparent whereupon a dense pattern of 0.1-0.2 mm cracks is evident in a slightly adherent but brittle film. When the same 3 mils wet film is dried immediately in the 70 deg. C. oven, it dries quickly to a nearly defect-free transparent and somewhat flexible film that is difficult to rub off When the emulsion was neutralized further with ammonia to pH 8.4, the appearance and viscosity remain unchanged but the degree of cracking was slightly reduced on drying, whether heated or not.

### Example (6)

Thermochromic coating: 349-19 is an irreversible thermochromic coating formulated from the crystalline polymer emulsion 350-112 described in example (5). 127.9 gr of binding polymer N-484 was stirred into 807.3 gr of 350-112 emulsion and followed with 19.4 gr of Acrysol TI-935 thickener pre-diluted with 30.5 gr of water. To this mixture was added 1.0 gr of Tego Foamex 1488 antifoam and finally 14.0 gr of 14% aqueous ammonia to neutralize and activate the thickener. The resulting coating formulation, at 48.1% NV solids and pH 8.0, equilibrated overnight to a thixotropic white paint with 1292 centipoise viscosity @ 60 rpm and 3670 centipoise @ 12 rpm (Brookfield LVT, #3 spindle@ 20 deg. C.). The polymer portion of this coating is comprised of 85.4% crystalline polymer, 13.4% binding polymer and 1.2% thickener polymer, or a ratio of 6.4 to 1 of crystalline to binding polymer. The coating, applied at 3 wet mils with Bird film applicator to a black Leneta chart, dried to an opaque white to a low sheen film at room temperature with a few barely visible cracks at the edges. The somewhat brittle coating adhered well to the chart and could be scraped off as small flakes. When the same wet film was dried at 50 deg. C., it reached the same level of opacity but with somewhat higher gloss, better adhesion and fewer defects. This dry film remained fully opaque with no to visible change until heated to 63 deg. C., whereupon it changed dramatically in about one minute, completely revealing the black chart background with no trace of opacity remaining, now adhering to the chart even more strongly than before though not quite as tough as the clear film formed when the coating is dried at 74 deg. C. When cooled back to room temperature, the film was non-tacky, remained fully transparent and could be bent over a ⅛″ mandrel without cracking.

### Example (7)

Crystalline polymer: 350-424 is a 0.72 micron median particle size anionic crystalline polymer emulsion at 51.0% NV solids neutralized with ammonia to pH 7.0 in 83:17 water:n-propanol with a viscosity of 28 centipoise. The dry polymer, based on a mixture of 93% docosyl acrylate, 4% 2-ethylhexyl acrylate. 2.5% methacrylic acid and 0.5% 1,6-hexanediol diacrylate, exhibits a strong endotherm at 53 deg. C. when tested by DSC at a 10 deg. C./min heating rate. When coated with 3 wet mils Bird film applicator on a black Leneta chart, the opaque white emulsion dried at room temperature to opaque white matte film that is easily rubbed from the chart to a flaky powder. The opaque film, when heated for 5 minutes in a 50 deg. C. oven, remained visibly unchanged until the temperature was increased to 54 deg. C. where it lost opacity but the residue appeared hazy due to the poorly adherent dense pattern of 0.1-0.2 mm in a film that turned brittle on cooling. When the same wet film was dried in the 74 deg. C. oven, it immediately lost opacity and became a nearly transparent but visibly cracked adherent film which was brittle on cooling that scratched easily but was somewhat difficult to rub off.

### Example (8)

Thermochromic coating: 349-20 is an irreversible thermochromic coating formulated from the crystalline polymer emulsion 350-124 described in example (7). 136.9 gr of binding polymer N-484 was stirred into 802.9 gr of 350-124 emulsion and followed with 26.0 gr of Acrysol TT-935 thickener pre-diluted with 20.8 gr of water. To this mixture was added 1.0 gr of Tego Foamex 1488 antifoam and finally 10.6 gr of 14% aqueous ammonia to neutralize and activate the thickener. The resulting coating formulation equilibrated overnight to 1010 centipoise viscosity at 48.5% NV solids and pH 8.5. The polymer portion of this coating is comprised of 83.5% crystalline polymer, 14.8% binding polymer and 1.7% thickener polymer, or a ratio of 5.7 to 1 of crystalline to binding polymer. This coating appeared very much like 349-19 in example (6), with comparable opacity when wet and dry, though with no visible defects even when dried at room temperature. It remained opaque even when dried at 50 deg. C. but, as expected, the dry film became transparent on heating to 54 deg. C. and remained so when cooled back to room temperature. The cooled film was more rigid but still flexible, non-tacky and easily handled without damage

### Example (9)

Crystalline polymer emulsion: 350-112 is a 0.76 micron median particle size anionic emulsion at 51.0% NV at pH 4.8 in 83:17 water:n-propanol with a viscosity of 28 centipoise. The dry lightly crosslinked polymer, based on a mixture of 9:3% docosyl acrylate, 4% 2-ethylhexyl acrylate, 2.5% methacrylic acid and 0.5% 1,6-hexanediol diacrylate, exhibits a strong endotherm at 62 deg. C. when tested by DSC at a 10 deg. C./min heating rate. When coated with #60 Meyer rod on a black Leneta chart, the opaque white emulsion dries at room temperature to opaque white but badly cracked film that is easily rubbed from the chart to a fine, flaky powder. This dry white polymer deposit, when heated for 2 minutes in a 70 deg. C. oven, became mostly transparent and showed a dense pattern of 0.1-0.2 mm cracks in a brittle film. The refractive index of this transparent but somewhat cracked film was tested using an ATAGO RS000 hand refractometer. The index at 30 deg. C. measured at about 1.50 in its crystalline state. The instrument could not, however, be heated safely to 65 deg. C. to measure it in the amorphous state. Uncrosslinked crystalline polymers made with similar composition (from octadecyl acrylate monomer) have been tested for refractive index giving a 1.46 index in their amorphous (melted) state.

### Example (10)

Crystalline polymer powder: 350-205 A is a powdered solid prepared from crystalline emulsion polymer 350-112 described in Example (1). 225 gr of 350-112 emulsion was chilled to 10 deg. C., poured into a chilled metal baking pan and the pan placed in a vacuum chamber over a bucket of dry ice. The polymer was freeze dried without agitation in this manner at 30 in Hg vacuum for 17 hours. The dry, white flaky residue was removed and placed in a pre-chilled Waring blender and pulverized for 1 minute at high speed. This powder was used to prepare several experimental reversible coatings. The 350-205 A powder was also suspended separately in methanol, sheared for 30 sec with a Virtis homogenizer and tested for particle size distribution with a Horiba LA-910 laser light scattering analyzer. The result indicated about 30% of the particles remained at 0.7 microns with the remaining agglomerates distributed between 3 and 30 microns.

### Example (11)

Reversible coating: 6.67 gr of Silgard 184, a dimethylsilicone based elastomer base resin from Dow Corning, was mixed with 4.0 gr 350-205 A, the powdered crystalline polymer from example (2), and 0.66 gr of Silgard 184 silicone curing agent plus additional platinum catalyst in the form of 6 drops Syl-Off 4000 (Platinum/vinyl siloxane based catalyst also from Dow Corning). The blend was mixed briefly with a spatula and then with Virtis homogenizer until free of lumps. The coating cured in 2 hours at room temperature to a grainy white rubbery film. The coating was heated to 70 deg. C. and it lost some but not all of its opacity when hot. On cooling back to room temperature the original degree of opacity returned. The incomplete transparency shown in the heated state is presumably due to a refractive index mismatch between the 1.43 RI silicone and the 1.46 RI crystalline polymer.

### Example (12)

Reversible coating: 6.03 gr of 350-412 crystalline polymer emulsion described in example (1) was diluted with 7.03 gr methanol and stirred in 0.12 gr Silwet L-77 (Polyalkylene modified heptamethyltrisiloxane—Osi Specialties), Added this smooth polymer suspension to 10.0 gr PDV-1631, a vinyl terminated diphenyl siloxane-dimethyl siloxane copolymer from Gelest with 16% diphenyl for a refractive index of 1.465. This siloxane/polymer mixture was homogenized for 1 minute using a Virtis hand-held homogenizer to a smooth white cream. To the creamy mixture was added 0.2 gr SIP6830.3, a divinyl tetramethyldisiloxane complex with 3% Pt from Gelest, followed by 0.25 gr S1P6826.0, a phenyltris(dimethysiloxy)silane crosslinker from (iciest. This catalyzed coating mixture, 349-56 C, was homogenized for one minute, applied to a black Leneta chart and cured 4 hours in an oven at 50 deg. C. The result, when cooled to room temperature, was a slightly opaque white rubbery film with some graininess from some agglomeration of the crystalline polymer powder. On heating to 70 deg. C., the film became almost completely transparent and on cooling again to room temperature, it regained opacity. In this example, we have a better match between the 1.465 RI silicone and the 1.46 RI crystalline polymer.

### Examples (13)

### Reversible Coating

A coating composition was made by mixing 48% by weight of Sylgard 184 (a Dow Corning silicone resin), 3% by weight of Sylgard 184 Dow Corning curing agent, 48% by weight of Polywax 655 from Baker Petrolite (Tp about 100 deg. C.), which had been micronized to a particle size of 3-10 mu, and 1% by weight of platinum. The coating composition was mixed with a homogenizer, knife coated on black paper to form a film. 0.001 inch (about 5.4 mu) thick, and cured. When the resulting coated paper was heated with a heat gun to a temperature above 100 deg. C., the coating became substantially transparent. On cooling, the coating again became opaque. This cycle could be repeated.

1. An indicator comprising:
a substrate, and
a coating on the substrate comprising a polymeric composition comprising one or more side chain crystalline (SCC) polymer(s) wherein when the composition is heated from a temperature below Ti to a temperature above Ti, the indicator changes color.

2. The indicator of claim 1, wherein the side chain crystalline (SCC) polymers can be homopolymers, or copolymers of two or more comonomers selected from the group consisting of random copolymers, graft copolymers, and block copolymers.

3. The indicator of claim 2, wherein the side chain crystalline (SCC) polymer is derived from one or more monomers selected from the group consisting of acrylic, methacrylic, olefinic, epoxy, vinyl, ester-containing, amide-containing, and ether-containing monomers.

4. The indicator of claim 1, wherein the indicator comprises components comprising 16 carbons and 12 carbons as a monomer or comonomer in the polymer.

5. The indicator of claim 1, wherein the side chain crystalline polymer is not crosslinked.

6. The indicator of claim 1, wherein the coating on the substrate contains a dye or pigment.

7. The method of claim 1, wherein the color change is irreversible.

8. The method of claim 1, wherein the color change is reversible.

9. An assembly which comprises
(1) a substrate which comprises a temperature-sensitive product, and
(2) a temperature indicator which
(a) comprises a side chain crystalline (SCC) polymer which (i) has a crystalline melting point, Tp, of 0-135° C., and (ii) is not cross-linked
(b) undergoes an irreversible change when exposed to a temperature which damages the temperature-sensitive product, wherein the change first occurs as the SCC polymer is exposed to temperature from below Tp to a temperature above Tp, wherein the SCC polymer is a copolymer of two or more comonomers, and comprises repeating units in which the side chains comprise linear polymethylene radicals containing 16-30 carbon atoms.

10. An assembly according to claim 9 wherein the SCC polymer is a copolymer which consists essentially of units derived from (a) the n-alkyl acrylate in which the n-alkyl group contains 12 carbon atoms and (b) the n-alkyl acrylate in which the n-alkyl group contains 16 carbon atoms.

11. An assembly according to claim 10 wherein the SCC polymer consists essentially of units derived from
(i) at least 50% by weight of at least one n-alkyl acrylate or methacrylate in which the n-alkyl group contains 12-50 carbon atoms, and
(ii) less than 50% by weight of at least one alkyl acrylate or methacrylate in which the alkyl group is not an alkyl group containing 12-50 carbon atoms.

12. An assembly according to claim 10 wherein the temperature indicator undergoes an irreversible change when exposed to a combination of time and temperature.

13. An assembly which comprises.
(1) a substrate, and.
(2) a temperature indicator which
(a) comprises a side chain crystalline (SCC) polymer which
(i) has a crystalline melting point, Tp, of 0-135° C.,
(ii) has a matrix polymer that is not crosslinked,
(iii) is a copolymer of two or more comonomers, and
(iv) comprises repeating units in which the side chains comprise linear polymethylene radicals containing 16-30 carbon atoms,
(v) has a heat of fusion of at least 20 J/g, and
(b) undergoes an irreversible change when exposed to a combination of time and temperature wherein the change first occurs when exposed to a temperature from below Tp to greater than Tp.

14. An assembly according to claim 13 wherein the SCC polymer is a copolymer which comprises repeating units containing an n-alkyl group which contains 12, 14, 16 or 18 carbon atoms.

15. An assembly according to claim 13 further comprising a dye or pigment.

16. An assembly according to claim 13 wherein the SCC polymer consists essentially of units derived from
(i) at least 50% by weight of at least one n-alkyl acrylate in which the n-alkyl group contains 12-50 carbon atoms, and
(ii) less than 50% by weight of at least one alkyl acrylate in which the alkyl group is not an alkyl group containing 12-50 carbon atoms.
